(19) United States
(12) Patent Application Publication
(10) Pub. No.: US 2022/0360833 A1
(43) Pub. Date: Nov. 10, 2022

(54) BLOCKCHAIN POWERED ROYALTY DISTRIBUTION

(71) Applicant: ARRIS Enterprises LLC, Suwanee, GA (US)

(72) Inventors: Manivannan Lalgudi KANNAN, Bengaluru (IN); Kanakendiran RAMACHANDIRAN, Bengaluru (IN)

(73) Assignee: ARRIS Enterprises LLC, Suwanee, GA (US)

(21) Appl. No.: 17/736,508

(22) Filed: May 4, 2022

Related U.S. Application Data
(60) Provisional application No. 63/183,947, filed on May 4, 2021.

(51) Int. Cl. H04N 21/254; H04N 21/2347; H04L 9/00

(52) U.S. Cl. CPC H04N 21/2541; H04N 21/2347; H04L 9/50

(57) ABSTRACT

A system and method for automatically distributing value received from the client for access to the media content is disclosed. The method comprises: defining a blockchain network, accepting a request for a media content transaction from the client, determining if the requested media content transaction complies with the value distribution agreement, and executing the requested media content transaction of the smart contract according to the determined compliance of the transaction with the value distribution agreement.

### BACKGROUND

### 1. Field

The present disclosure relates to systems and methods for providing access to media content and in particular to a system and method for automatically distributing value received for providing access to the media content.

### 2. Description of the Related Art

The dissemination of media content typically involves a plurality of entities, each of which have a role in the provision of the media content to the consumer, and a stake in obtaining at least a portion of the value received in consideration of the provision in the media content in exchange for the services or content provided. In systems largely supported by a single entity (traditional cable or satellite television service provider), the dissemination of this value is reasonably straightforward, as such systems typically provide their own digital rights management systems and contract with content providers for the media content. However, media content distribution paradigms are evolving away from such models, with a rise in liquid subscriptions and services and multifold modes of content consumption. This raises the possibility of new parties to the transaction including the entity providing digital rights management services for the transaction instead of through equipment provided and maintained by the service provider. Further, some distribution systems (for example, over the top or OTT systems) may eliminate the service provider (e.g. clients receive media content directly from the content provider), eliminate the content provider (e.g. the media content is ultimately generated by the service provider instead of the content provider), or have a single entity share the roles of both the service provider and the content provider.

This results in opaque and inefficient compensation mechanisms. For example, in a paradigm wherein the service provider obtains media content from the content provider in exchange for a set fee per media content instance, the content provider is given little visibility into the amount of value received for providing the media program, and must either trust or audit the service provider to assure value is being distributed as agreed. Audits are time consuming and typically need manual reconciliation. Further, there is no standard computational model defining how values are to be distributed, nor a single source of truth regarding transaction details. As a result, transactions between the client, the service provider, and the content provider can result in erroneous, inefficient, and/or ambiguous transactions, pools of unclaimed and/or unsettled royalties, exposure to lawsuits, and disrupted content delivery.

### SUMMARY

To address the requirements described above, this document discloses a system and method for automatically distributing value received from the client for access to the media content. The method is used in a media content distribution system comprising a media content provider, a service provider, a digital rights management provider, and comprises: defining a blockchain network, accepting a request for a media content transaction from the client, determining if the requested media content transaction complies with the value distribution agreement, and executing the requested media content transaction of the smart contract according to the determined compliance of the transaction with the value distribution agreement. The blockchain network includes a plurality of member nodes, the plurality of member nodes and a smart contract between the plurality of member nodes, the smart contract associated with a blockchain and automatically implementing a value distribution agreement. The plurality of member nodes comprises at least one of a media content provider node uniquely associated with the media content provider and a service provider node uniquely associated with the service provider, and a digital rights management node uniquely associated with the digital rights management provider and the client.

Another embodiment is evidenced by a system for automatically distributing value received from the client for access to the media content. The system comprises a blockchain network and a smart contract between the plurality of member nodes, the smart contract associated with a blockchain and automatically implementing a value distribution agreement, the smart contract for determining if the requested media content transaction complies with the value distribution agreement and executing the requested media content transaction of the smart contract according to the determined compliance of the transaction with the value distribution agreement. The blockchain network comprises a plurality of member nodes, comprising at least one of a media content provider node uniquely associated with the media content provider and a service provider node uniquely associated with the service provider, the service provider node for accepting a request for a media content transaction from the client, and a digital rights management node uniquely associated with the digital rights management provider.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

Referring now to the drawings in which like reference numbers represent corresponding parts throughout:

FIG. 1 is a diagram illustrating an exemplary content distribution system.

FIG. 2 is a diagram illustrating one embodiment of a method for automatically distributing value received from a client for access to media content within the content distribution system.

FIG. 3 is a diagram illustrating a blockchain network that automatically distributes value received from clients for access to media content to member nodes of a media content distribution system.

FIG. 4 is a diagram illustrating an example of the generation of the blockchain implemented smart contract.

FIGS. 5A and 5B are diagrams providing further details regarding the provision of media content and distribution of value.

FIGS. 6A and 6B are drawings illustrating exemplary user interfaces provided by the web interfaces.

FIG. 7 is a diagram illustrating further details of the content provider interface.

FIG. 8 is a diagram illustrating one embodiment of a content provider interface used to add an asset to the blockchain.

FIG. 9 a diagram illustrating further details of the service provider interface.

FIG. 10 is a diagram illustrating one embodiment of the service provider interface used to add a user to the blockchain.

FIG. 11 is a diagram of an exemplary user interface presented by the client device for selection of media content to request access.

FIGS. 12A and 12B are diagrams showing the user interfaces and after the transaction is approved.

FIGS. 13A and 13B are diagrams illustrating an exemplary playback interface.

FIG. 14 is a diagram illustrating further details of the blockchain interface.

FIG. 15 is a diagram depicting an embodiment of the blockchain interface when the transactions control is selected.

FIG. 16 depicts an embodiment of a window showing additional details regarding a transaction.

FIG. 17 illustrates an exemplary computer system that could be used to implement processing elements of this disclosure.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Overview

As described above, the fact that OTT and similar paradigms create transactions having multiple actors creates a need for coordinated and synchronized transactions among multiple stake holders. Since the actors are not typically in a trusting relationship, there is a need to establish a level of trust among the entities and transparent methods to resolve disputes. Since reconciliation can be tedious, there is a need for an efficient mechanism to verify transactions and to account for them. The use of a standard computation model results in a need for smart contracts to define dependency between transactions. Also, there is a need for a structured repository of information that includes contracts and transactions. Disclosed below is a method for disseminating value among entities that is powered by blockchain technique that defines smart contracts between content delivery stake holders that may include a content originator, content provider, service provider and digital rights management provider. The technique enforces dependencies throughout the content distribution channel that ensures reliable and transparent royalty settlements.

The technique significantly reduces operational inefficiencies in the process of managing rights and royalties management, eliminates the need for costly manual reconciliation and partner reviews, provides near real-time and exact allocation and distribution of royalty payments according to usage, based on smart contracts (black boxes are no longer required), is cost efficient because no costly tracking and monitoring systems for usage required (as every consumption/usage will be tracked in the blockchain), provides a new role of collection associations—blockchain platform provider and verification of smart contract details through collection associations as trusted third parties, and allows easy addition of stake holders and is thus open to all standard business models.

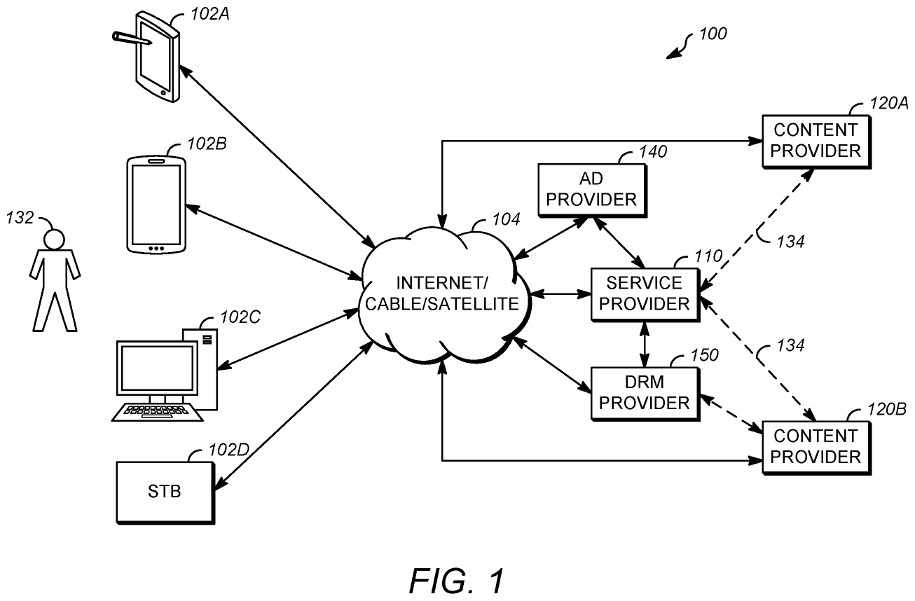

FIG. 1 is a diagram illustrating an exemplary content distribution system (CDS) 100. In the illustrated embodiment, the CDS 100 may comprise one or more content providers 120A, 120B (hereinafter, content provider(s) 120), in communication with a communication network 104 such as the Internet, a cable system, or a satellite system. One example of a content provider is HOME BOX OFFICE (HBO).

The CDS 100 transmits content data having content to one or more client devices 102A-102D, also alternatively referred to herein as clients. Such client devices 102 may include a tablet 102A, a smartphone 102B, a desktop or laptop computer 102C and/or a set top box (STB) 102D. client devices 102 may both be enabled to receive content from the service provider 110 or directly from the content providers 120.

Typically, content providers 120 own the rights to the media programs (alternatively referred to hereinafter as “content” ultimately presented to consumers. Content providers 120 may own such rights because they created the content itself, or by transfer of rights from the authors or former owners of the content.

In one service paradigm, content providers 120 transmit content to one or more service providers 110 (typically over high bandwidth secure communication links 134), and the services providers 110 transmit the content to the client devices 102. One example of a service provider is a cable service such as SPECTRUM, satellite broadcast system such as DISH or Over-the-Top (OTT) service. In another service paradigm, the content providers 120 transmit content directly to client devices 102. In the first service paradigm, the service provider 110 licenses the content from the content providers 120. In the second service paradigm, the content provider 120 license the content directly to the client devices 102. Content providers 120 may also be service providers 110 and vice versa (for example, HULU creates content and distributes it).

The content providers 120 and service providers 110 each may include one or more video servers and one or more databases for storing and transmitting content. Content providers 120 and service providers 110 may transmit content data to the client devices 102 via the Internet, cable transmission system, satellite transmission system, or terrestrial transmission, and such transmission may comprise a broadcast (e.g. transmission to any client device 102 via a communication channel shared by the client devices 102, multicast (e.g. transmission to a pre-specified group of client devices 102), or by OTT video-on-demand and/or streaming.

The content data transmitted to client devices 102 includes the content itself (e.g. the video and audio data that together comprise the program of content) as well as other data appurtenant to the content provided to the client device 102 and used to support the decompression and decoding of the content or otherwise present the content. Such appurtenant data can include, for example, clock references, program identifiers, conditional access data, catalogs of media programs and the like.

Using the client devices 102, remote users 132 can also communicate data with the service provider(s) 110 or content provider(s) 120 using the communication network 104.

The CDS 100 may also comprise one or more advertisement providers 140, which supply advertising content that is presented conjunction with the content, typically at intervals within the content. In the illustrated embodiment, the advertisement provider 140 includes an advertisement provider server communicatively coupled to an associated and communicatively coupled advertisement provider database.

As there is value in restricting access to media program to paying subscribers, the CDS 100 typically include a digital rights management (DRM) system. Typically, the DRM system operates by encrypting, encoding, or otherwise obfuscating the media content in such a way that only authorized client devices 102 can decrypt, decode or deobfuscate the media content. In some embodiments, the DRM system is implemented and managed by the service provider 110 or content provider, and the service provider 110 or content provider 120 encrypt the media content and provide the means to decrypt the media content to authorized client devices 102. In other embodiments, the DRM system is provided by a third party DRM provider 150, which provides the means by which the service provider 110 or content provider 120 encrypt the media content (for example, encryption algorithms, encryption keys and related hardware if any), and also provide the means to the client devices 102 to decrypt the content for playback (e.g. decryption keys, software, and related hardware if any). The means to decrypt or decode the media content is typically provided in a license transmitted to the client device. Typically, an independent (not owned or managed by a service provider 110 or content provider 120) provides DRM services to more than one content provider 120 and/or service provider 110.

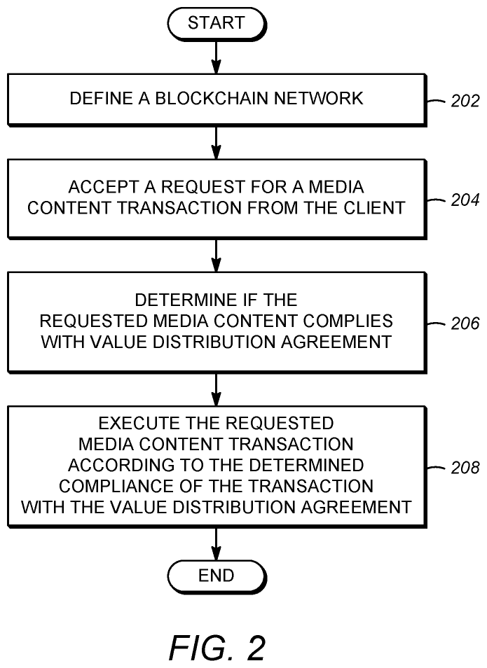

FIG. 2 is a diagram illustrating one embodiment of a method for automatically distributing value received from a client device 102 for access to media content within the CDS 100. In block 202, a blockchain network 300 is defined.

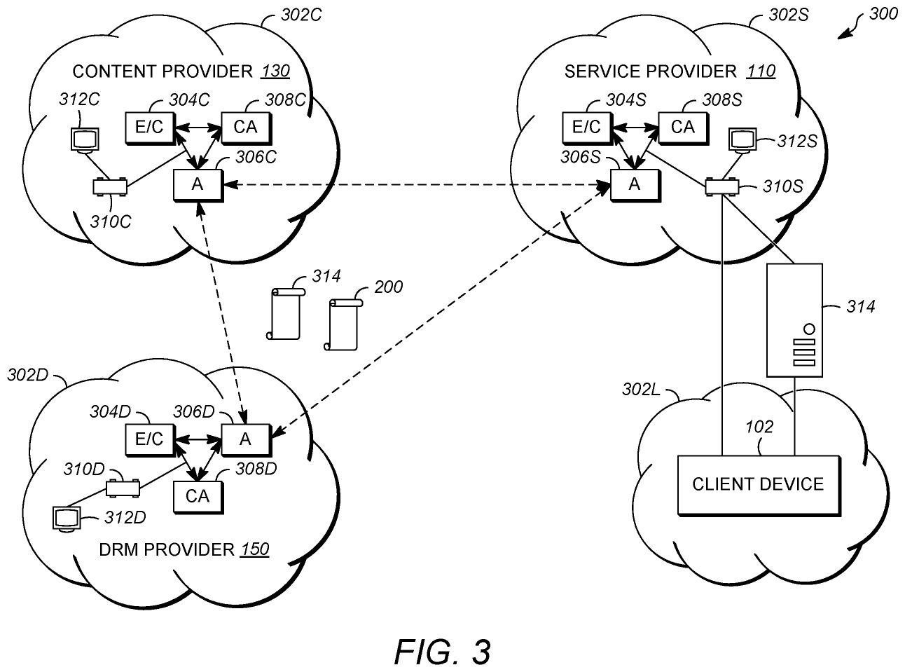

FIG. 3 is a diagram illustrating a blockchain network 300 that automatically distributes value received from clients for access to media content to member nodes of the CDS 100. The blockchain network 300 is a network of nodes (implemented by computers) that run software that confirms transactions on the blockchain network 300. The blockchain network 300 comprises a plurality of member nodes 302, each uniquely associated with an element of the CDS 100. For example, in a CDS 100 having one content provider 120, one service provider 110 and one DRM provider, the blockchain network 300 comprises a member nodes 302 that include a content provider node 300C typically uniquely associated with the content provider 120, a service provider node 302S uniquely associated with the service provider 110, and a DRM node 302D uniquely associated with the DRM provider.

The blockchain network 300 comprises a plurality of member nodes 302 including at least one media content provider node 302C uniquely associated with a media content provider 120 and a service provider node 302S uniquely associated with a service provider 110. The blockchain network 300 implements a blockchain 200 and a smart contract 314 between the plurality of member nodes 302 and automatically implements a value distribution agreement entered between the member nodes 302. A smart contract 314 is an agreement between two people in the form of computer code. They run on the blockchain network 300, so they are stored on a public database and cannot be changed. The transactions that happen in a smart contract 314 are processed by the blockchain 200, which means they can be sent automatically without a third party. The transactions only happen when the conditions in the agreement are met—there is no third party, so there are no issues with trust.

In one embodiment, the blockchain 200 forms a part of a Hyperledger fabric having a plurality of member nodes. In this embodiment, each of the member nodes 302 in the blockchain network 300 includes an endorser peer and a committer peer (hereinafter endorser/committer (EC) peer), including service provider node EC peer 304S, content provider node EC peer 304C and DRM provider node peer 304D (hereinafter alternatively collectively referred to as EC peers 340) that, for that associated member node 302, endorses transactions to the smart contract 314, maintains the ledger, and commits transactions to the smart contract 314. Each of the member nodes 302 also includes a certificate authority (CA) node. These include service provider CA node 208S, content provider CA node 208C, and DRM provider CA node 208D (alternatively hereinafter described as CA nodes 308). In response to requests to enroll members received in a membership service provider (MSP), these CA nodes 308 issue identities (certificates and associated key pairs) to the peers in the same respective node's blockchain 200, and users of the blockchain network 300. In one embodiment, the CA nodes 308 issue and store only public keys. Private keys are generated and stored by the member node prior to invoking an enroll API (which generates a certificate signing request having the public key and submits the certificate signing request to the associated CA node 308 of the member node. A particular server may implement multiple node CAs 308, and a node CAs 308 may be a node root CA or an node intermediate CA.

Each member node 302 also includes an anchor peer, including service provider anchor peer 306S, content provider anchor peer 306C, and DRM provider anchor peer 306D (hereinafter alternatively referred to as anchor peers 306), which communicates with the anchor peers 306 of other member nodes 302 in the blockchain network 300. Within each member node 302, the EC peer 304, CA node 308 and anchor peer 306 are communicatively coupled to exchange messages and information. Each member node 302 has at least one node processing device 310 such as a composer REST server, which exposes the blockchain transactions, preferably as a web service. The node processing devices include administration portals 312 that actually perform the blockchain transactions, track revenue, and other useful metrics. This embodiment of the blockchain network 300 may be created with the use of a Hyperledger composer model.

Returning to FIG. 2, block 204 a request for media content is accepted from a client device 102. Block 206 determines whether the requested media content complies with the value distribution agreement implemented by the smart contract 314. Finally, block 208 executes the requested media content transaction according to the determined compliance with the value distribution agreement.

In one embodiment, such client access to the requested media content is typically provided only if the requested media content transaction complies with the value distribution agreement. In another embodiment, the client is provided access to the requested media content, and the non-compliance of the requested media content transaction with the value distribution agreement is recorded, thus providing the client access to the media content, and allowing the parties to the smart contract 314 (e.g. the member nodes 302). After such recording, the parties to the agreement can determine how best to handle the transaction without denying service to the requesting client device 102. Providing the client device 102 access to the media content can be implemented by providing the client data or other means that allow the client device 102 to access and play the requested media content. For example, in the typical embodiment wherein the media content is encrypted, providing access to the media content may comprise transmitting information enabling the client device to decrypt the encrypted media content. Such information can comprise a decryption key or key parameters that the client device 102 can use to generate the required decryption key.

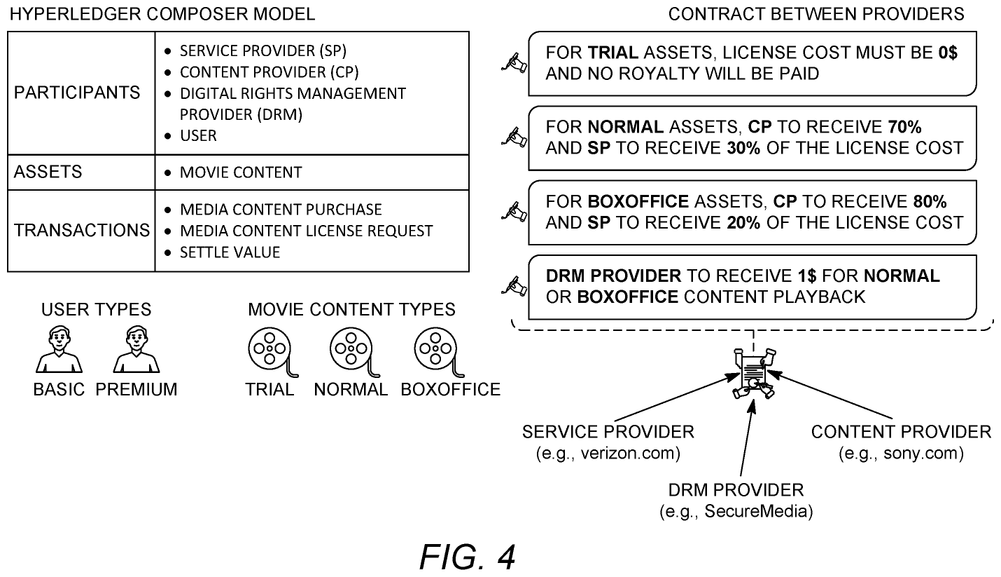

FIG. 4 is a diagram illustrating an example of the generation of the blockchain implemented smart contract 314. A Hyperledger composer model defines the participants (member nodes 302), assets (media content), and transaction types. In the illustrated embodiment, the participant member nodes include the service provider, the content provider, the DRM provider, and the user or client. The assets include movies and other media content, and the supported transaction types include a media content purchase transaction, a media content license transaction, and a settle value transaction. Other transactions such as a check asset rights transaction, and a pay DRM royalty transaction may be included. In this example, there are two user or client types: (1) basic and (2) premium according to a subscription privilege level, and three asset (e.g. media content) classifications or types: (1) trial, (2) normal, and (3) box office. The smart contract 314 implemented in this example the defines the following value distributions depending upon the asset classification such as media content type and the a client classification such as client (user) type. As indicated, the value distribution agreement in this example specifies that for trial assets (media content), the license cost to the client is zero, and no royalty is paid. For normal media content, the content provider 120 (represented by the content provider member node 302C) receives 70% of the royalties paid by the client device 102 to access the media content, and the service provider 110 (represented by the service provider member node 302S) receives 30% of the royalties paid by the client device 102. For box office media content, the content provider 120 receives 80% of the royalties paid by the client device 102, and the service provider 110 receives 20% of the royalties paid by the client device 102. Finally, for normal or box office media content types, the DRM provider 150 is to receive one dollar for access to the media content. Use cases are provided below using the foregoing example.

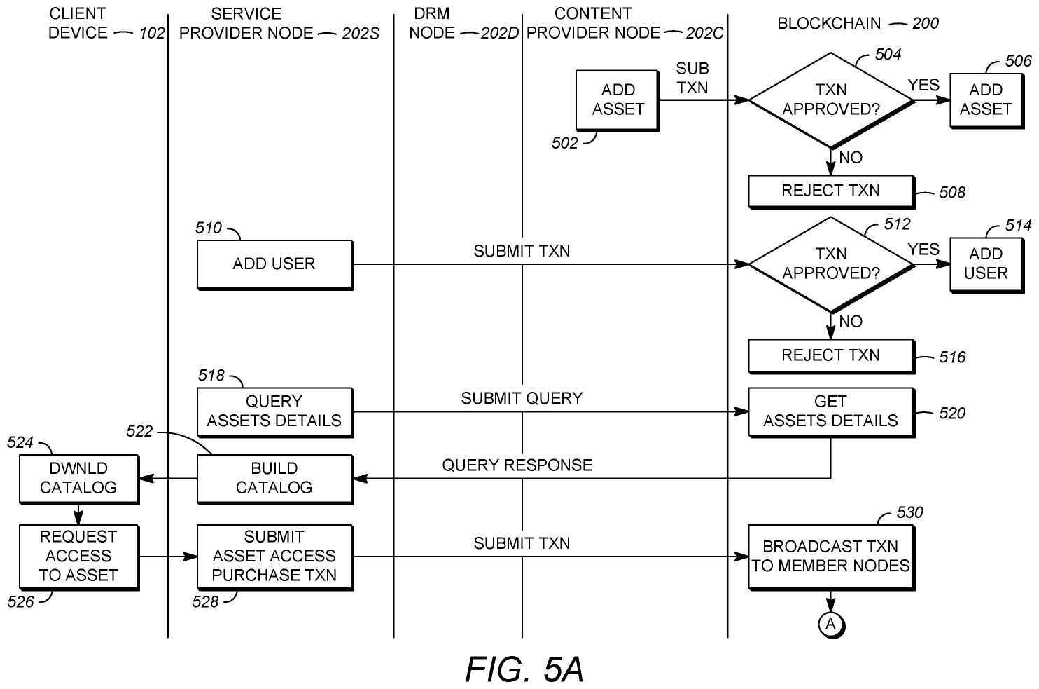

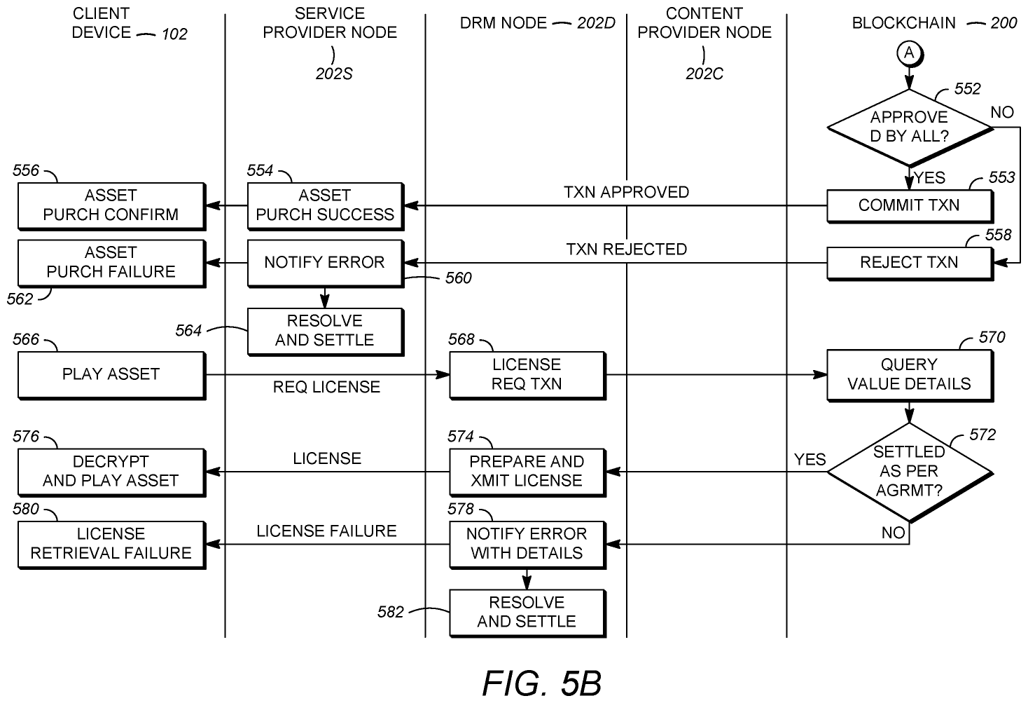

FIGS. 5A and 5B are diagrams providing further details regarding the provision of media content and distribution of value. The process begins in block 502, where the content provider node 200C requests a transaction to add an asset to the blockchain 200.

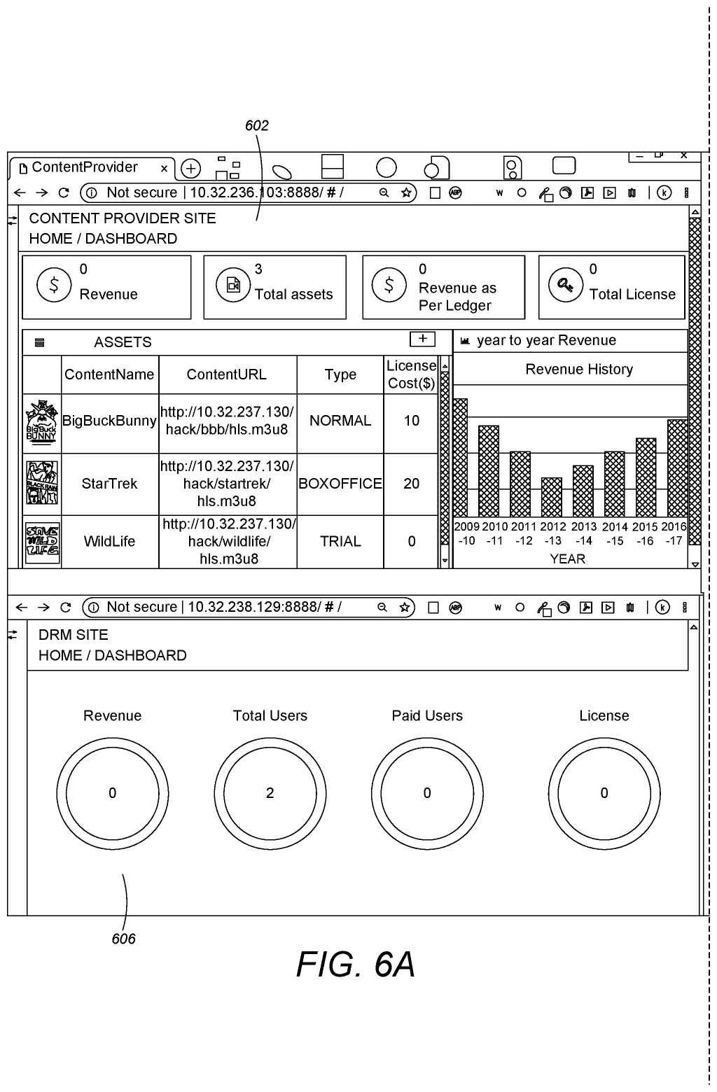

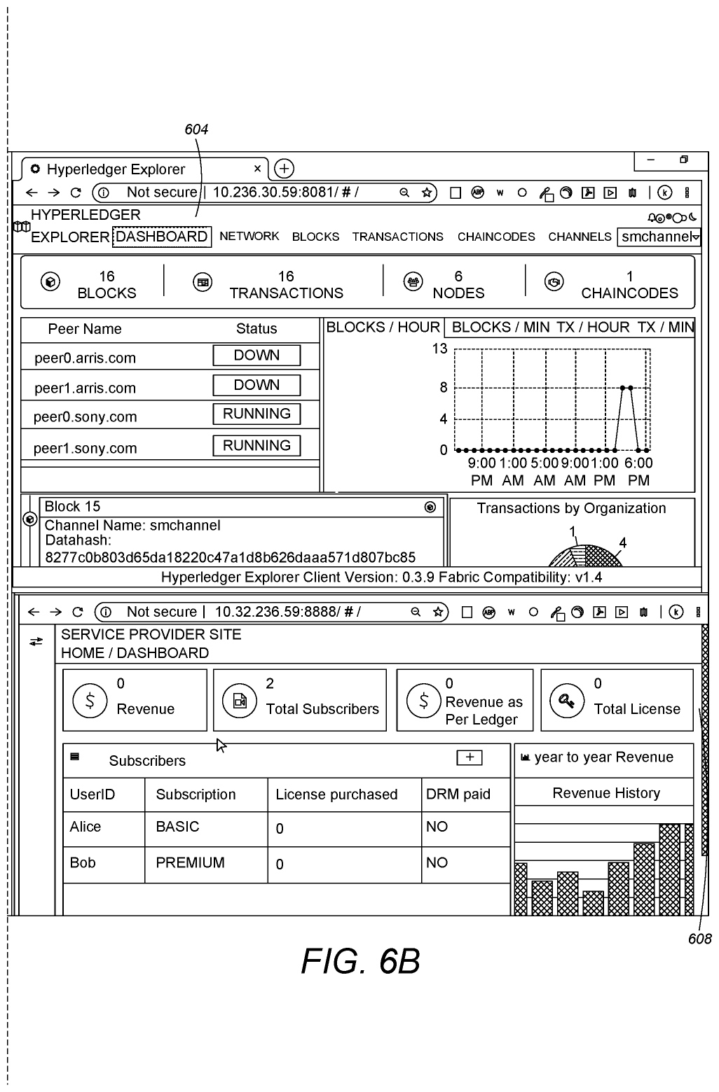

FIG. 6 is a drawing illustrating exemplary user interfaces provided by the web interfaces 312C, 312S, and 312D, including content provider interface 602, service provider interface 608 and DRM provider node web service interface 606. Also illustrated is a blockchain interface 604.

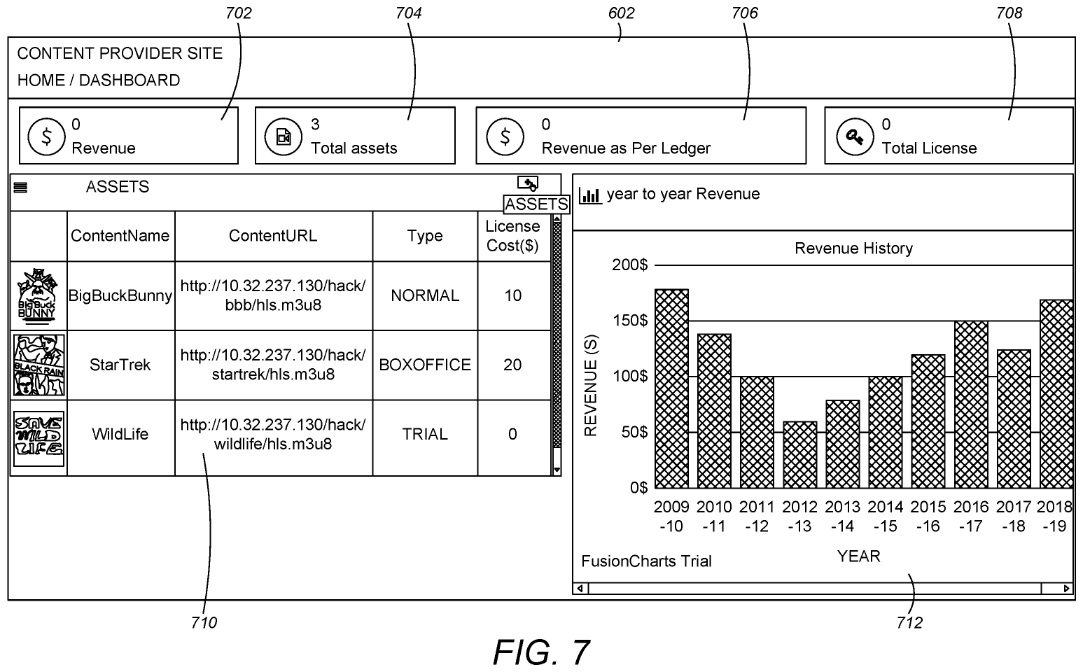

FIG. 7 is a diagram illustrating further details of the content provider interface 602. As illustrated, the interface 602 has a first portion 702 indicating derived revenue, a second portion 704 indicating the total number of assets, a third portion 706 depicting revenue as determined by the ledger of the blockchain, and a fourth portion 708 indicating the total number of licenses. Also included is a fourth portion 710 providing a list of assets, including the asset name, URL, type, and license fee for that asset. An optional fifth portion 712 indicates a history of revenue or other information.

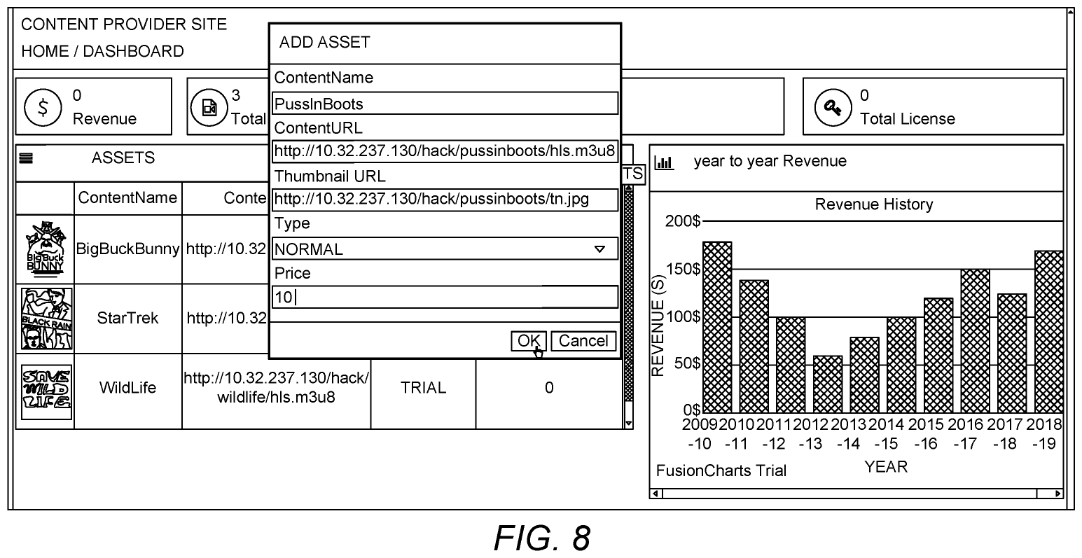

FIG. 8 is a diagram illustrating one embodiment of a content provider interface used to add an asset to the blockchain. In the illustrated example, the input form depicted allows the user to enter the content name, URL, a URL of a thumbnail of the content, the content type, and the price for a single view of the content. Additional information can also be included, which may vary by content type. For example, if the content is available for outright purchase, a field can be used to enter this information as well. After adding the content, the content appears in the list of assets in the fourth portion 710.

Returning to FIG. 5A, the blockchain 200 receives the request and block 504 determines if the requested transaction is approved. A transaction might not be approved, for example, if the media type of the added asset was not among the asset types defined in the blockchain as described above, as the value distribution agreement regarding that undefined type of asset may be unsettled. If the transaction is approved, block 504 routes processing to block 506 where the asset is added to the blockchain 200. If the asset is not approved, block 506 routes processing to block 508, where the transaction is rejected. Although not illustrated, a message can be transmitted to the content provider node 200C indicating the transaction has been rejected. At another time or concurrently, the service provider node 202S generates a request to add a user (subscriber), as shown in block 510, and transmits that request to the blockchain 200. The blockchain 200 receives the request, and determines if the transaction should be approved, as shown in block 512. If the transaction is approved (e.g. user should be added), processing is routed to block 514, and the user is added to the blockchain. If the transaction is not approved, block 512 routes processing to block 516, which rejects the transaction.

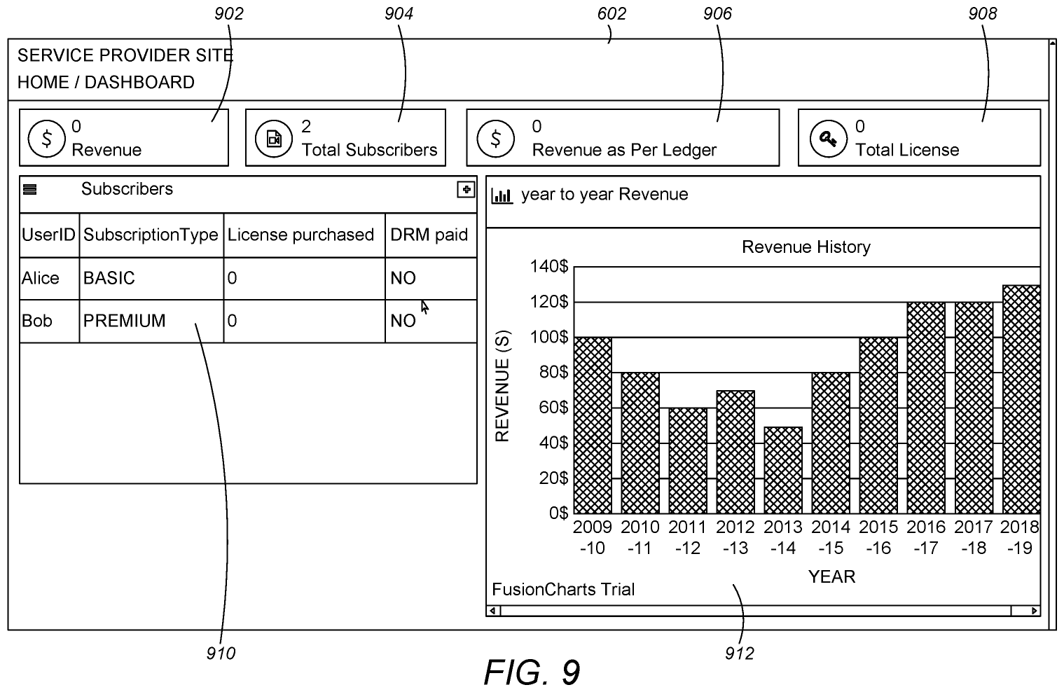

FIG. 9 a diagram illustrating further details of one embodiment of the service provider interface 602. As illustrated, the interface 604 has a first portion 902 indicating derived revenue, a second portion 904 indicating the total number of assets, a third portion 906 depicting revenue as determined by the ledger of the blockchain, and a fourth portion 908 indicating the total number of licenses. Also included is a fourth portion 910 providing a list of users, subscription type, number of licenses purchased, and whether the DRM fees have been paid. An optional fifth portion 912 indicates a history of revenue or other information.

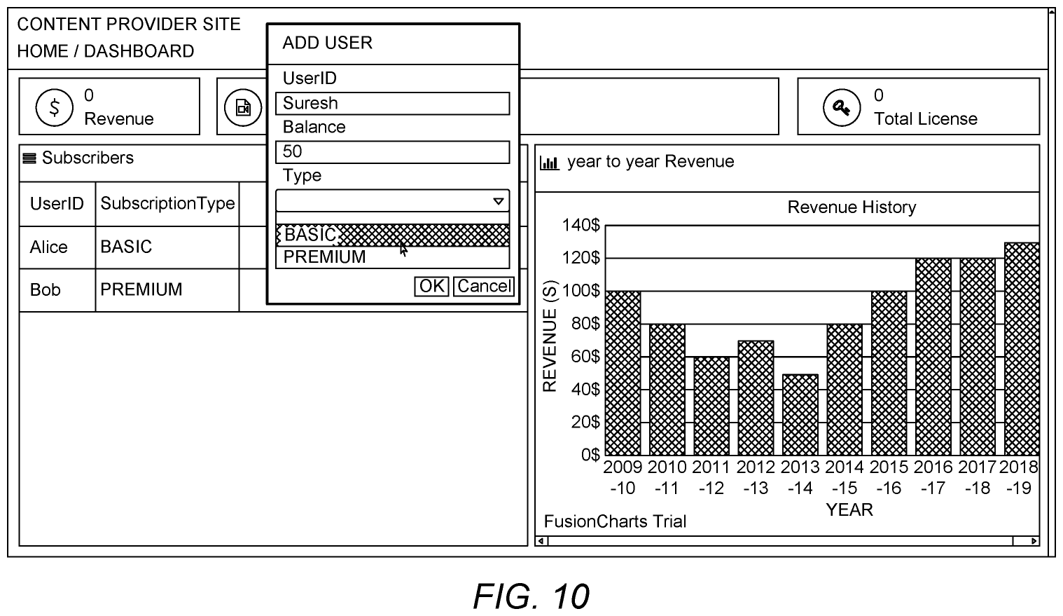

FIG. 10 is a diagram illustrating one embodiment of the service provider interface used to add a user to the blockchain. In the illustrated example, the input form depicted allows the user to enter the user ID, the balance on the user's account, and the type of subscription. Additional information can also be included, which may vary by client (e.g. user) type. After adding the user, the user appears in the list of users in the fourth portion 910.

Returning again to FIG. 5A, in block 518, the service provider node 202S queries the blockchain 200 for details of the assets provided by the content provider node(s) 302C and included in the blockchain 200. In block 520, the blockchain retrieves the details of the assets and transmits the details to the service provider node 202S. In block 522, the service provider node builds a catalog of assets, as shown in block 522.

As shown in block 524, the client device 102 operating on the client member node 302L can download the catalog. The user can use the client device 102 to request access to an asset, as shown in block 526.

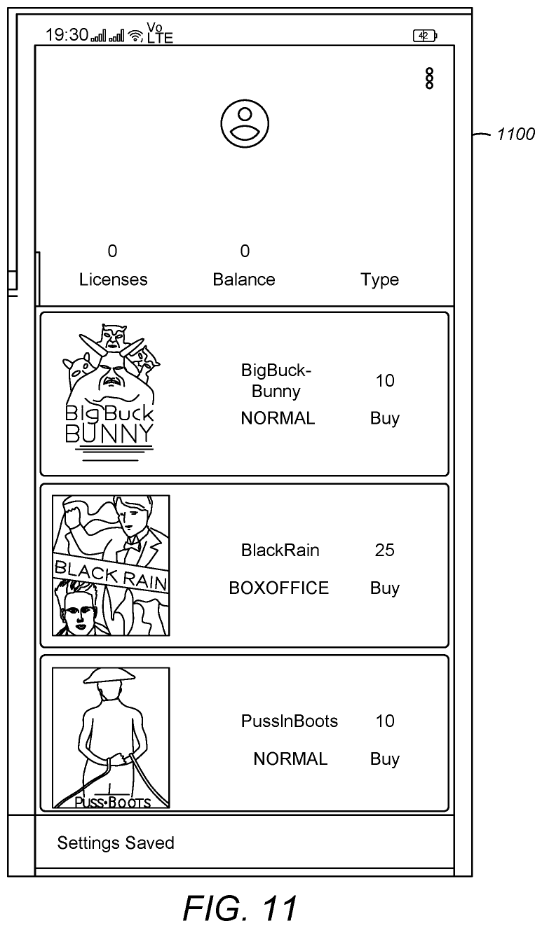

FIG. 11 is a diagram of an exemplary user interface 1100 presented by the client device 102 for selection of media content to request access. As shown, the client is presented with representations of one or more assets (media programs), and the user may request access to the asset by selecting the asset, in the illustrated case, by selecting the term “buy.”

The request to access the asset is transmitted from the client device 102 to either the service provider node 202S or the content provider node 302C (depending on to which entity the user is subscribed). The service provider node 302S or the content provider node 302C then creates a media content purchase transaction as shown in block 528. That transaction is submitted to the associated member node of the blockchain 200. The blockchain 200 receives the submitted transaction, and broadcasts the transaction to the member nodes 302 for approval (endorsement) as shown in block 530. Processing is then routed to block 552, which determines if the proposed transaction is approved by all member nodes (e.g. the service provider node 302S, the content provider node 302C and the DRM node 302D) under the value distribution agreement implemented by the smart contract 314. If the terms are satisfied, the transaction is approved, and the transaction is committed to the ledgers of each of the member nodes 302, and the blockchain automatically distributes the value of the transaction according to the value distribution agreement of the smart contract 314 as shown in block 553. A message is transmitted to the service provider node 202S, indicating that the asset was successfully purchased as shown in block 554. The service provider node 202S may send an associated message to the client device 102, confirming purchase of the asset, as shown in block 556. If the transaction is not approved by all member nodes 302, the transaction is rejected, as shown in block 558. The blockchain 200 then transmits a message to the service provider indicating that the transaction was rejected, as shown in block 560. The service provider node 202S can then attempt to resolve and settle the reasons for the rejection of the transaction by requesting a settle transaction as shown in block 564, and also transmit a message indicating that the transaction was rejected and the asset has not been purchased, as shown in block 562.

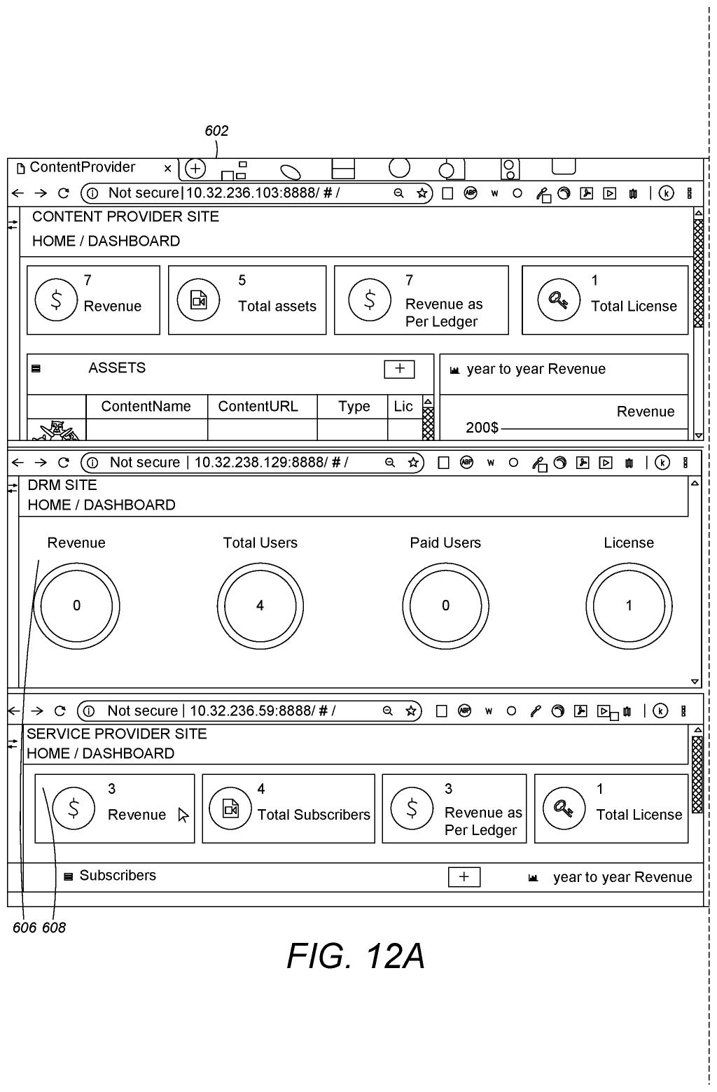

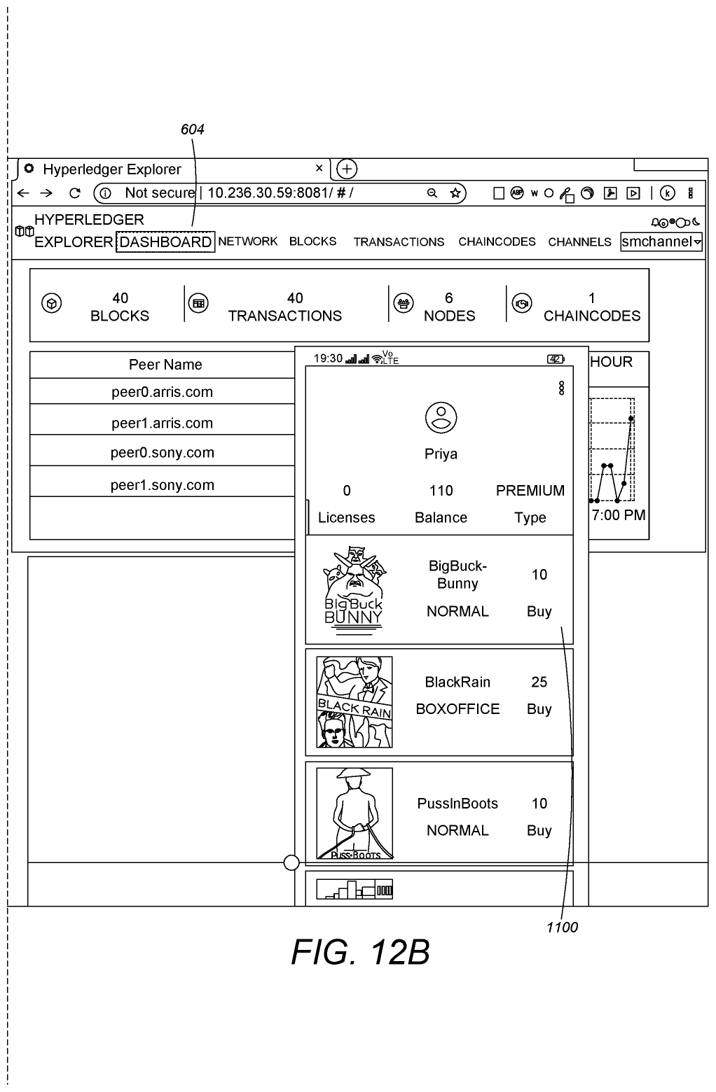

FIG. 12 is a diagram showing the user interfaces 602-608 and 1100 after the transaction is approved. Note that since the transaction involves a $10 payment in which the content provider receives 70% of the value and the service provider receives 30% of the value, the content provider interface 602 has changed to reflect the $7 increase in value and the additional license, while the service provider interface 608 has changed to reflect the $3 increase in value and the additional license. Also note that the revenues as indicated by the blockchain ledger reflect these changes. Notice also that the DRM provider interface 606 reflects the increase in licenses, but no increased revenue, as the value distribution agreement of the smart contract 314 predicates payment on the playback of the media content, which has yet to occur.

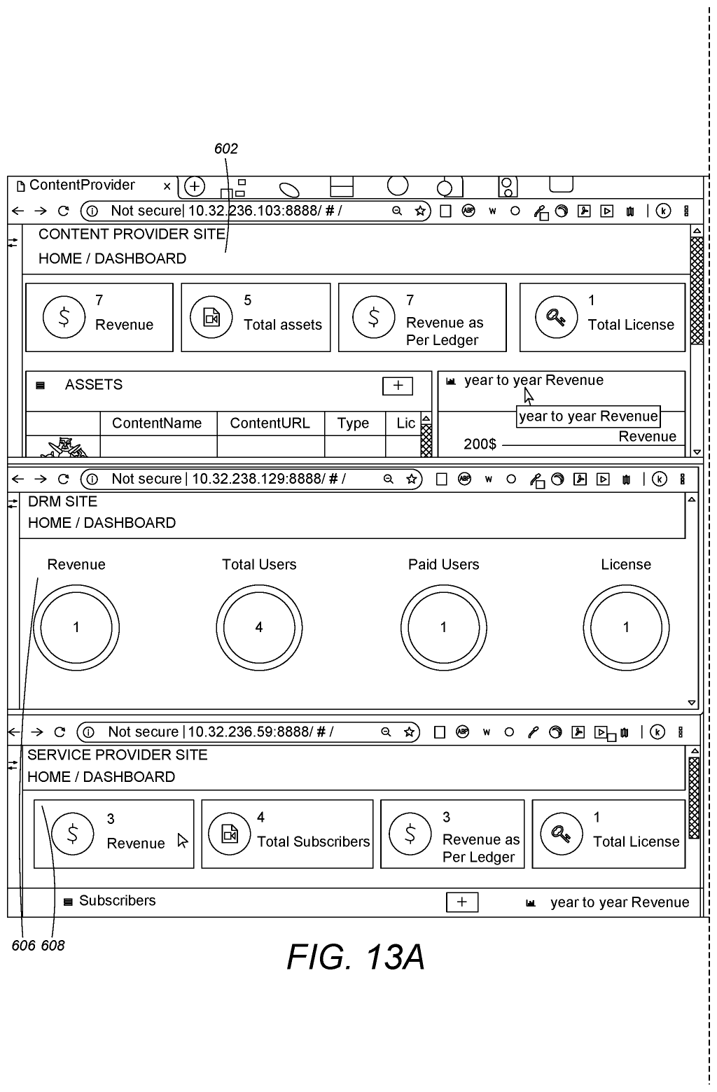

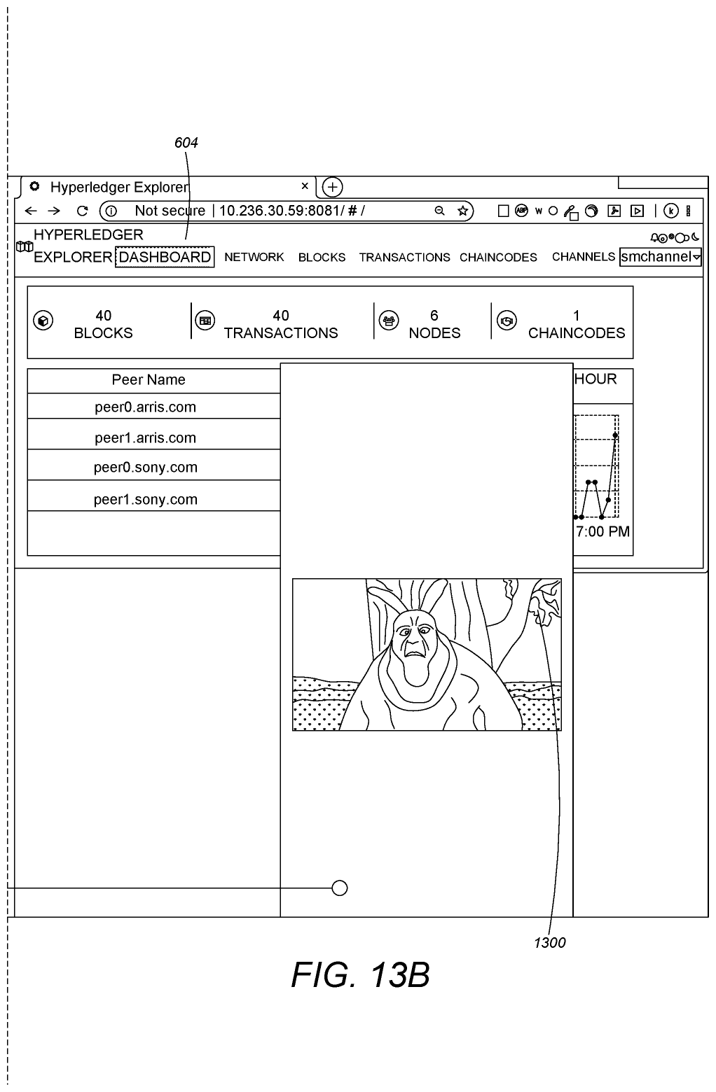

Returning to FIG. 5B, in block 566, the client device 102 issues a request to play the asset, which results in a license request transmitted to the DRM node 202D. The DRM node 202D generates and transmits a media content license request transaction to the blockchain 200, as shown in block 568. In block 570, the blockchain 200 queries the smart contract 314 to determine the value distribution agreement. Block 572 determines if the values have been settled according to the value distribution agreement. If so, the blockchain 200 sends a message to the DRM node to prepare information such as a license and transmit the information to the client device, as shown in block 574. The license includes a key or other information that enables decryption of encrypted media content. The client device can then decrypt and play the asset as shown in block 576 and in the playback interface 1300 of FIG. 13. If the value has not been distributed and settled as per the value distribution agreement implemented in the smart contract 314, block 572 routes processing to block 578 where the DRM node transmits a message to the client device 102 to notify the device of the a failure to retrieve a license for the specified asset. The message is received by the client device 102 in block 580. In block 582, the DRM node 202D attempts to resolve and settle the disparity that prevented the blockchain from approving the license request transaction, for example, by requesting a settle transaction. In one embodiment, block 572 instructs the DRM node to provide the license to provide the client access to the requested media content even if the transaction is not settled as per the agreement, but routes processing to block 578 to record the non-compliance of the requested media transaction and notify the DRM node 202D of the error with details regarding the transaction, so that the transaction can be resolved and future license transactions proceed without failure.

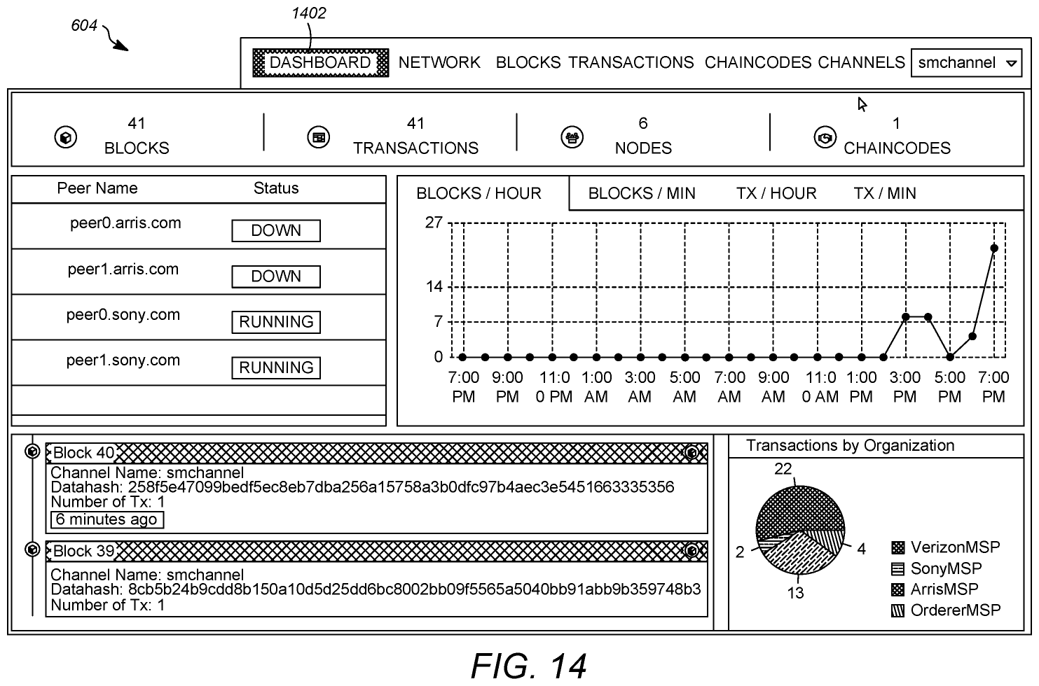

FIG. 14 is a diagram illustrating further details of the blockchain interface 604. Having captured transparent transactions at all member nodes 302, an analytical engine or an analytical process component can be used to allow participating member nodes to determine transaction patters such as: (1) patterns of specific media being decoded at the DRM provider, (2) pattern of measuring individual stockholder monitory benefits, and (3) pattern of media consumption (e.g. content type, user type). The exemplary blockchain interface 604 illustrated in FIG. 14 is a dashboard selected by selecting control 1402, and indicates how many blocks are in the ledger, how many transactions, how many nodes have participated in transactions, and how many chain codes have been built on a top portion. The identity (peer name) and status of peer nodes is identified in a first portion of the interface 604, while individual blocks are listed in a second portion of the interface 604. System metrics such as new blocks or transactions per time period can be graphed in a third section of the interface 604, and other metrics such as the number of transactions by organization can be indicated in the fourth portion of the interface 604.

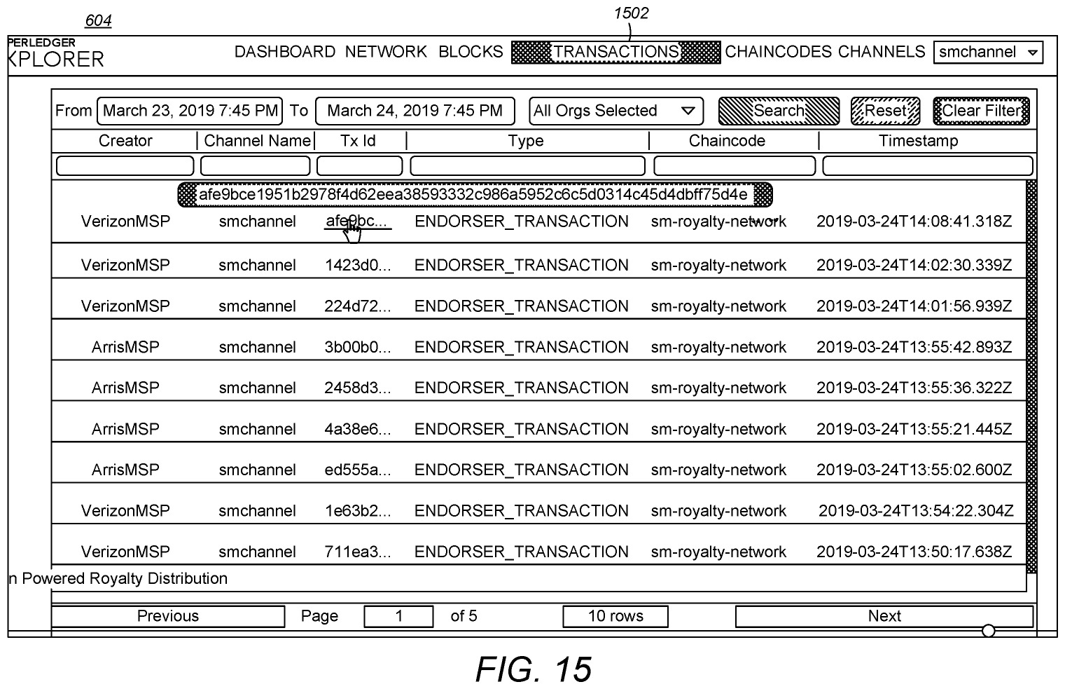

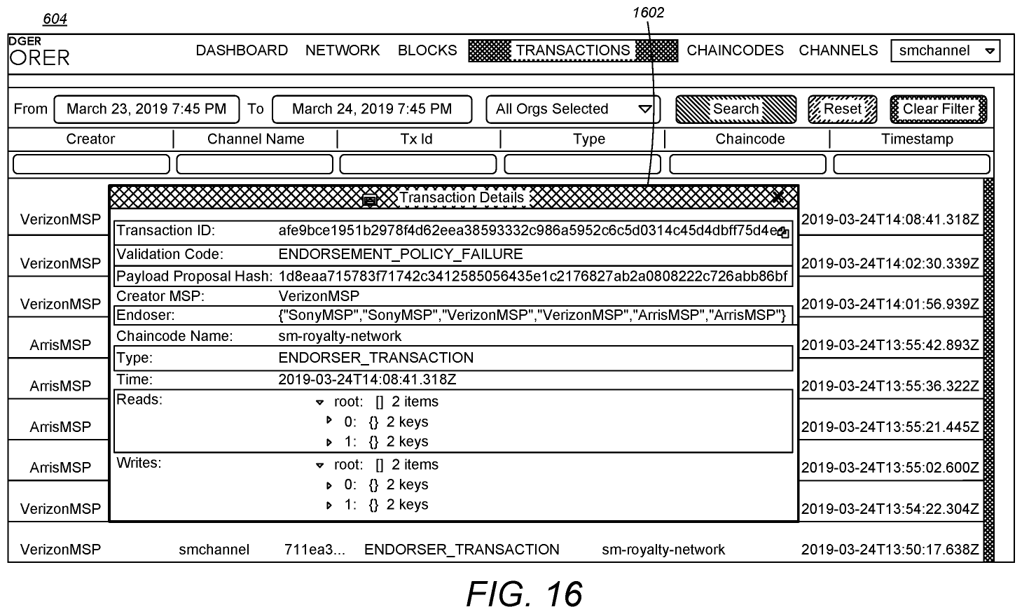

FIG. 15 depicts an embodiment of the blockchain interface 604 when the transactions control 1502 is selected. Temporal windows are provided to select the time period for which transactions are desired to be examined, as well as controls to select which entities are involved in the transactions, and to perform other filtering. Upon selection the transactions are listed, with the creator of the transaction, the channel name, the transaction identifier, the transaction type, the chain code, and a timestamp indicating when the transaction took place. Selection of the transaction identifier allows additional transaction details to be presented in a transaction details window 1602, as shown in FIG. 16.

### Exemplary Use Cases

The use cases below are considered in a case wherein the value distribution agreement of the smart contract 314 requires (1) for trial type assets that the license cost is 0$ and no royalty paid, (2) for normal type assets, the content provider node 302C is to receive 70% of the license cost and the service provider 110 is to receive 30% of the license cost, (3) for box office type assets, the content provider 120 is to receive 80% of the license cost and the service provider node 110 is to receive 20% of the license cost, and (4) the DRM provider 150 is to receive a fee of $1 for normal or box office content playback for all users. Further, we assume that the service provider node requires a value distribution agreement wherein (1) for box office content, the service provider 110 receives 30% of the royalty and the content provider 120 receives 70%, and that the service provider 110 will pay the DRM provider 150 only for premium user types.

First Use Case: Purchase and playback of a normal asset by a premium user. Since all requirements of the value distribution agreement are met, all member node peers will endorse this transaction, and purchase and playback will take place.

Second Use Case: In this case, a purchase of box office content is made. Since the service provider node 202S uses a 30-70% split for box office content, but the value distribution agreement of the smart contract 314 demands a 20-80% split between the service provider node 202S and the content provider node 302C, this contract will not be endorsed by the service provider, and the purchase and playback will not take place.

Third Use Case: In this case, a purchase of a normal asset is made by a basic user. Since the service provider node 202S pays the DRM node 202D only for premium users, an endorsement failure will occur when the client device attempts to retrieve a key from the DRM provider 150 for playback.

Further Third Use Case: Further to the third use case above, if the service provider agrees to pay the DRM royalty for all users, the request can be resubmitted, and the DRM royalty is paid, and playback can be retried.

### Hardware Environment

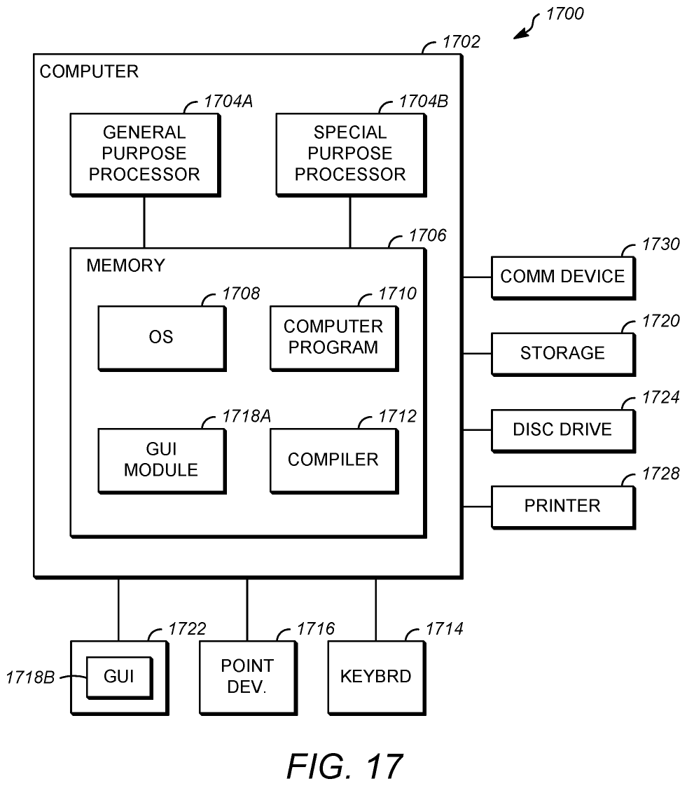

FIG. 17 illustrates an exemplary computer system 1700 that could be used to implement processing elements of the above disclosure, including the service provider, service provider node, content provider, content provider node, DRM provider, DRM provider node, client device and client, and ad provider 140. The computer 1702 comprises a processor 1704 and a memory, such as random access memory (RAM) 1706. The computer 1702 is operatively coupled to a display 1722, which presents images such as windows to the user on a graphical user interface 1718B. The computer 1702 may be coupled to other devices, such as a keyboard 1714, a mouse device 1716, a printer 1728, etc. Of course, those skilled in the art will recognize that any combination of the above components, or any number of different components, peripherals, and other devices, may be used with the computer 1702.

Generally, the computer 1702 operates under control of an operating system 1708 stored in the memory 1706, and interfaces with the user to accept inputs and commands and to present results through a graphical user interface (GUI) module 1718A. Although the GUI module 1718B is depicted as a separate module, the instructions performing the GUI functions can be resident or distributed in the operating system 1708, the computer program 1710, or implemented with special purpose memory and processors. The computer 1702 also implements a compiler 1712 which allows an application program 1710 written in a programming language such as COBOL, C++, FORTRAN, or other language to be translated into processor 1704 readable code. After completion, the application 1710 accesses and manipulates data stored in the memory 1706 of the computer 1702 using the relationships and logic that was generated using the compiler 1712. The computer 1702 also optionally comprises an external communication device 1730 such as a modem, satellite link, Ethernet card, or other device for communicating with other computers.

In one embodiment, instructions implementing the operating system 1708, the computer program 1710, and the compiler 1712 are tangibly embodied in a computer-readable medium, e.g., data storage device 1720, which could include one or more fixed or removable data storage devices, such as a zip drive, floppy disc drive 1724, hard drive, CD-ROM drive, tape drive, etc. Further, the operating system 1708 and the computer program 1710 are comprised of instructions which, when read and executed by the computer 1702, causes the computer 1702 to perform the operations herein described. Computer program 1710 and/or operating instructions may also be tangibly embodied in memory 1706 and/or data communications devices, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

### CONCLUSION

This concludes the description of the preferred embodiments of the present disclosure.

The foregoing discloses a system and method for automatically distributing value received from the client for access to the media content. The method is used in a media content distribution system comprising a media content provider, a service provider, a digital rights management provider, and comprises: defining a blockchain network, accepting a request for a media content transaction from the client, determining if the requested media content transaction complies with the value distribution agreement, and executing the requested media content transaction of the smart contract according to the determined compliance of the transaction with the value distribution agreement. The blockchain network includes a plurality of member nodes, the plurality of member nodes and a smart contract between the plurality of member nodes, the smart contract associated with a blockchain and automatically implementing a value distribution agreement. The plurality of member nodes comprises at least one of a media content provider node uniquely associated with the media content provider and a service provider node uniquely associated with the service provider, and a digital rights management node uniquely associated with the digital rights management provider and the client.

Implementations may include one or more of the following features:

Any of the methods described above, wherein executing the requested media content transaction of the smart contract according to the determined compliance of the transaction with the value distribution agreement includes: providing the client access to the requested media content only if the requested media content transaction complies with the value distribution agreement.

Any of the methods described above, wherein executing the requested media content transaction of the smart contract according to the determined compliance of the transaction with the value distribution agreement includes: providing the client access to the requested media content and recording non-compliance of the requested media content transaction if the requested media content transaction does not comply with the value distribution agreement.

Any of the methods described above, wherein the media content is encrypted and executing the requested media content transaction includes transmitting information enabling decryption of the encrypted media content.

Any of the methods described above, wherein the transaction is one of a plurality of media content transaction types; the client is one of a plurality of client types defined according to a subscription privilege level; the media content is one of a plurality of media content types defined according to an asset classification; and the value distribution agreement defines an allocation of the value between the plurality of member nodes according to transaction type, user type, and media content type.

Any of the methods described above, wherein the plurality of media content transaction types includes: a media content purchase transaction; a media content license request transaction; a settle value transaction; the plurality of client types include: a basic client type; and a premium client type the plurality of media content types include: a trial media content type; a normal media content type; and a box office media content type.

Any of the methods described above, wherein the blockchain forms part of a Hyperledger fabric; wherein each member node includes: a plurality of peers including: an endorser and committer peer, for endorsing transactions to the smart contract and maintaining a ledger and committing the transactions to the smart contract; an anchor peer, for communicating with each of the other member nodes; a certificate authority node, for issuing identities to each of the plurality of the peers. The method may also include the smart contract and the blockchain are defined by a Hyperledger composer.

Any of the methods described above, wherein the media content provider node includes a media content provider node web service interface for adding new media content having one of the media content types and a license fee; the digital rights management node includes a digital rights management node web service interface for viewing total users, licenses, paid users, and revenue; and the service provider node includes a service provider node interface for adding a new user to blockchain network, the new user of one of the user types and purchasing a license.

Another embodiment is evidenced by a system for automatically distributing value received from the client for access to the media content. The system comprises a blockchain network and a smart contract between the plurality of member nodes, the smart contract associated with a blockchain and automatically implementing a value distribution agreement, the smart contract for determining if the requested media content transaction complies with the value distribution agreement and executing the requested media content transaction of the smart contract according to the determined compliance of the transaction with the value distribution agreement. The blockchain network comprises a plurality of member nodes, comprising at least one of a media content provider node uniquely associated with the media content provider and a service provider node uniquely associated with the service provider, the service provider node for accepting a request for a media content transaction from the client, and a digital rights management node uniquely associated with the digital rights management provider.

Implementations may include one or more of the following features:

Any system described above, wherein the client is provided access to the requested media content only if the requested media content transaction complies with the value distribution agreement.

Any system described above, wherein the smart contract provides the client access to the requested media content and records non-compliance of the requested media content transaction if the requested media content transaction does not comply with the value distribution agreement.

Any system described above, wherein the media content is encrypted and the requested media content transaction is executed by transmitting information enabling decryption of the encrypted media content.

Any system described above, wherein the transaction is one of a plurality of media content transaction types; the client is one of a plurality of client types defined according to a subscription privilege level; the media content is one of a plurality of media content types defined according to an asset classification; and the value distribution agreement defines an allocation of the value between the plurality of member nodes according to transaction type, user type, and media content type.

Any system described above, wherein the plurality of media content transaction types includes: a media content purchase transaction; a media content license request transaction; a settle value transaction; the plurality of client types include: a basic user type; and a premium user type the plurality of media content types include: a trial media content type; a normal media content type; and a box office media content type.

Any system described above, wherein the blockchain forms part of a Hyperledger fabric; wherein each member node includes: a plurality of peers including: an endorser and committer peer, for endorsing transactions to the smart contract and maintaining a ledger and committing the transactions to the smart contract; an anchor peer, for communicating with each of the other member nodes; a certificate authority node, for issuing identities to each of the plurality of the peers. The system may also include a Hyperledger composer communicatively coupled to the endorser peer, committer peer and the anchor peer, for defining the smart contract and the blockchain.

Any system described above, wherein the media content provider node includes a media content provider node web service interface for adding new media content having one of the media content types and a license fee; the digital rights management node includes a digital rights management node web service interface for viewing total users, licenses, paid users, and revenue; and the service provider node includes a service provider node interface for adding a new user to blockchain network, the new user of one of the user types and purchasing a license.

The features, functions, and advantages that have been discussed can be achieved independently in various embodiments of the present invention or may be combined in yet other embodiments, further details of which can be seen with reference to the foregoing description and drawings.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. In a media content distribution system comprising a media content provider, a service provider, a digital rights management provider, and a client, a method of automatically distributing value received from the client for access to the media content, comprising:
defining a blockchain network having:
a plurality of member nodes, the plurality of member nodes comprising:
at least one of a media content provider node uniquely associated with the media content provider and a service provider node uniquely associated with the service provider;
a digital rights management node uniquely associated with the digital rights management provider; and
a smart contract between the plurality of member nodes, the smart contract associated with a blockchain and automatically implementing a value distribution agreement;
accepting a request for a media content transaction from the client;
determining if the requested media content transaction complies with the value distribution agreement; and
executing the requested media content transaction of the smart contract according to the determined compliance of the transaction with the value distribution agreement.

2. The method of claim 1, wherein executing the requested media content transaction of the smart contract according to the determined compliance of the transaction with the value distribution agreement comprises:
providing the client access to the requested media content only if the requested media content transaction complies with the value distribution agreement.

3. The method of claim 1, wherein executing the requested media content transaction of the smart contract according to the determined compliance of the transaction with the value distribution agreement comprises:
providing the client access to the requested media content and recording non-compliance of the requested media content transaction if the requested media content transaction does not comply with the value distribution agreement.

4. The method of claim 1, wherein the media content is encrypted and executing the requested media content transaction comprises transmitting information enabling decryption of the encrypted media content.

5. The method of claim 1, wherein:
wherein the transaction is one of a plurality of media content transaction types;
the client is one of a plurality of client types defined according to a subscription privilege level;
the media content is one of a plurality of media content types defined according to an asset classification; and
the value distribution agreement defines an allocation of the value between the plurality of member nodes according to transaction type, user type, and media content type.

6. The method of claim 5, wherein:
the plurality of media content transaction types comprises:
a media content purchase transaction;
a media content license request transaction;
a settle value transaction;
the plurality of client types include:
a basic client type; and
a premium client type
the plurality of media content types include:
a trial media content type;
a normal media content type; and
a box office media content type.

7. The method of claim 1, wherein:
the blockchain forms part of a Hyperledger fabric;
wherein each member node comprises:
a plurality of peers including:
an endorser and committer peer, for endorsing transactions to the smart contract and maintaining a ledger and committing the transactions to the smart contract;
an anchor peer, for communicating with each of the other member nodes;
a certificate authority node, for issuing identities to each of the plurality of the peers; and
the smart contract and the blockchain are defined by a Hyperledger composer.

8. The method of claim 7, wherein:
the media content provider node comprises a media content provider node web service interface for adding new media content having one of the media content types and a license fee;
the digital rights management node comprises a digital rights management node web service interface for viewing total users, licenses, paid users, and revenue; and
the service provider node comprises a service provider node interface for adding a new user to blockchain network, the new user of one of the user types and purchasing a license.

9. In a media content distribution system comprising a media content provider, a service provider, a digital rights management provider, and a client, a system for automatically distributing value received from the client for access to the media content, comprising:
a blockchain network having:
a plurality of member nodes, the plurality of member nodes comprising:
at least one of a media content provider node uniquely associated with the media content provider;
a service provider node uniquely associated with the service provider, the service provider node for accepting a request for a media content transaction from the client; and
a digital rights management node uniquely associated with the digital rights management provider; and
a smart contract between the plurality of member nodes, the smart contract associated with a blockchain and automatically implementing a value distribution agreement, the smart contract for determining if the requested media content transaction complies with the value distribution agreement and executing the requested media content transaction of the smart contract according to the determined compliance of the transaction with the value distribution agreement.

10. The system of claim 9, wherein the client is provided access to the requested media content only if the requested media content transaction complies with the value distribution agreement.

11. The system of claim 9, wherein the smart contract provides the client access to the requested media content and records non-compliance of the requested media content transaction if the requested media content transaction does not comply with the value distribution agreement.

12. The system of claim 9, wherein the media content is encrypted and the requested media content transaction is executed by transmitting information enabling decryption of the encrypted media content.

13. The system of claim 9, wherein:
wherein the transaction is one of a plurality of media content transaction types;
the client is one of a plurality of client types defined according to a subscription privilege level;
the media content is one of a plurality of media content types defined according to an asset classification; and
the value distribution agreement defines an allocation of the value between the plurality of member nodes according to transaction type, user type, and media content type.

14. The system of claim 13, wherein:
the plurality of media content transaction types comprises:
a media content purchase transaction;
a media content license request transaction;
a settle value transaction;
the plurality of client types include:
a basic user type; and
a premium user type
the plurality of media content types include:
a trial media content type;
a normal media content type; and
a box office media content type.

15. The system of claim 9, wherein:
the blockchain forms part of a Hyperledger fabric;
wherein each member node comprises:
a plurality of peers including:
an endorser and committer peer, for endorsing transactions to the smart contract and maintaining a ledger and committing the transactions to the smart contract;
an anchor peer, for communicating with each of the other member nodes;
a certificate authority node, for issuing identities to each of the plurality of the peers; and
a Hyperledger composer communicatively coupled to the endorser peer, committer peer and the anchor peer, for defining the smart contract and the blockchain.

16. The system of claim 15, wherein:
the media content provider node comprises a media content provider node web service interface for adding new media content having one of the media content types and a license fee;
the digital rights management node comprises a digital rights management node web service interface for viewing total users, licenses, paid users, and revenue; and
the service provider node comprises a service provider node interface for adding a new user to blockchain network, the new user of one of the user types and purchasing a license.

17. In a media content distribution system comprising a media content provider, a service provider, a digital rights management provider, and a client, an apparatus for automatically distributing value received from the client for access to the media content, comprising:
means for defining a blockchain network having:
a plurality of member nodes, the plurality of member nodes comprising:
at least one of a media content provider node uniquely associated with the media content provider and a service provider node uniquely associated with the service provider;
a digital rights management node uniquely associated with the digital rights management provider; and
a smart contract between the plurality of member nodes, the smart contract associated with a blockchain and automatically implementing a value distribution agreement;
means for accepting a request for a media content transaction from the client;
means for determining if the requested media content transaction complies with the value distribution agreement; and
means for executing the requested media content transaction of the smart contract according to the determined compliance of the transaction with the value distribution agreement.

18. The apparatus of claim 17, wherein the means for executing the requested media content transaction of the smart contract according to the determined compliance of the transaction with the value distribution agreement comprises:
means for providing the client access to the requested media content only if the requested media content transaction complies with the value distribution agreement.

19. The apparatus of claim 17, wherein executing the requested media content transaction of the smart contract according to the determined compliance of the transaction with the value distribution agreement comprises:
means for providing the client access to the requested media content and recording non-compliance of the requested media content transaction if the requested media content transaction does not comply with the value distribution agreement.

20. The apparatus of claim 17, wherein the media content is encrypted and executing the requested media content transaction comprises transmitting information enabling decryption of the encrypted media content.
